(19) United States
(12) Patent Application Publication
(10) Pub. No.: US 2021/0099718 A1
(43) Pub. Date: Apr. 1, 2021

(54) ENCODING DEVICE AND ENCODING METHOD

(71) Applicant: Panasonic Intellectual Property Management Co., Ltd., Osaka (JP)

(72) Inventors: Yuki MARUYAMA, Osaka (JP); Hiroya KUSAKA, Hyogo (JP); Taro IMAGAWA, Osaka (JP); Akihiro NODA, Osaka (JP)

(21) Appl. No.: 17/120,900

(22) Filed: Dec. 14, 2020

Related U.S. Application Data
(63) Continuation of application No. PCT/JP2019/022250, filed on Jun. 5, 2019.

(30) Foreign Application Priority Data
Aug. 24, 2018 (JP) 2018-157066

(51) Int. Cl. H04N 19/167; H04N 19/543; H04N 19/176

(52) U.S. Cl. CPC H04N 19/167; H04N 19/176; H04N 19/543

(57) ABSTRACT

An encoding device that compression-encodes a plurality of images to measure local displacement of the structure includes: a determiner that determines, as a first region in the plurality of images to be used to measure local displacement of the structure; and an encoder that encodes the first region using a first parameter and encodes a second region different from the first region using a second parameter. The first parameter is a coding parameter yielding less loss of image information due to lossy compression than the second parameter.

### CROSS REFERENCE TO RELATED APPLICATIONS

This application is a U.S. continuation application of PCT International Patent Application Number PCT/JP2019/022250 filed on Jun. 5, 2019, claiming the benefit of priority of Japanese Patent Application Number 2018-157066 filed on Aug. 24, 2018, the entire contents of which are hereby incorporated by reference.

### BACKGROUND

### 1. Technical Field

The present disclosure relates to an encoding device and an encoding method that compression-encode a plurality of images for measuring local displacement of a structure.

### 2. Description of the Related Art

To prevent collapse and/or breakdown of infrastructure (such as bridges and tunnels) due to aging degradation, a periodic inspection of the structure is required to conduct a necessary repair. As such a periodic inspection, an appearance inspection is often visually conducted by an inspection crew. However, such a visual inspection of appearance by an inspection crew is difficult to yield an objective inspection result, and the inspection cost is high and the burden on the inspection crew is large.

In view of the above, a technique for inspecting a structure using an image of the structure captured by a camera is suggested. For example, in Patent Literature 1 (Japanese Unexamined Patent Application Publication No. 2017-215306), minute displacement over time of a structure is detected using images in which an object to be measured is captured at a plurality of times.

### SUMMARY

However, high-definition images are necessary to detect minute displacement of a structure. Because of this, when the images are compressed at a low compression rate, the amount of data of the images is enormous. On the other hand, when the images are lossy-compressed at a high compression rate, loss of the image information increases and minute displacement of a structure may not be detected.

In view of the above, the present disclosure provides an encoding device and an encoding method that effectively compression-encode a plurality of images for measuring local displacement of a structure.

An encoding device according to one aspect of the present disclosure is an encoding device that compression-encodes a plurality of images of a structure including a first image and a second image and being captured at mutually different times to measure local displacement of the structure. The encoding device includes: an inputter that receives input of a third region in the first image from a user; a determiner that performs motion estimation, between the first image and the second image, on each of regions obtained by dividing the third region in the first image, and determines, as a first region to be used to measure local displacement of the structure, a region including a region having a degree of reliability of the motion estimation higher than a threshold degree of reliability from among the regions; and an encoder that encodes the first region using a first parameter and encodes a second region different from the first region using a second parameter. The first parameter is a coding parameter yielding less loss of image information due to lossy compression than the second parameter.

Note that these comprehensive or specific aspects of the present disclosure may be implemented as a system, a method, an integrated circuit, a computer program, or a computer-readable recording medium such as a CD-ROM, or may be implemented as any combination of a system, a method, an integrated circuit, a computer program, and a recording medium.

The encoding device according to one aspect of the present disclosure effectively compression-encodes a plurality of images for measuring local displacement of a structure.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a block diagram of an inspection system according to an embodiment;

FIG. 2 is a flowchart of a process of an encoding device according to the embodiment;

FIG. 3 is a diagram of an exemplary image according to the embodiment;

FIG. 4 is a diagram of an exemplary image according to the embodiment;

FIG. 5 is a diagram of an exemplary image according to the embodiment; and

FIG. 6 is a flowchart of a process of an inspection device according to the embodiment.

### DETAILED DESCRIPTION OF THE EMBODIMENT

The following specifically describes an embodiment with reference to the drawings.

Note that the embodiment described below shows a general or specific example. The numerical values, shapes, materials, structural elements, the arrangement and connection of the structural elements, steps and the order of the steps mentioned in the following embodiment are mere examples and not intended to limit the claims. Of the structural elements in the following embodiment, structural elements not recited in any one of the independent claims representing broadest concepts are described as optional structural elements. Note that the figures are not necessarily precise depictions. Moreover, throughout the figures, structural elements that are essentially the same share like reference signs, and duplicate description is omitted or simplified.

### Embodiment

### [Configuration of Inspection System 10]

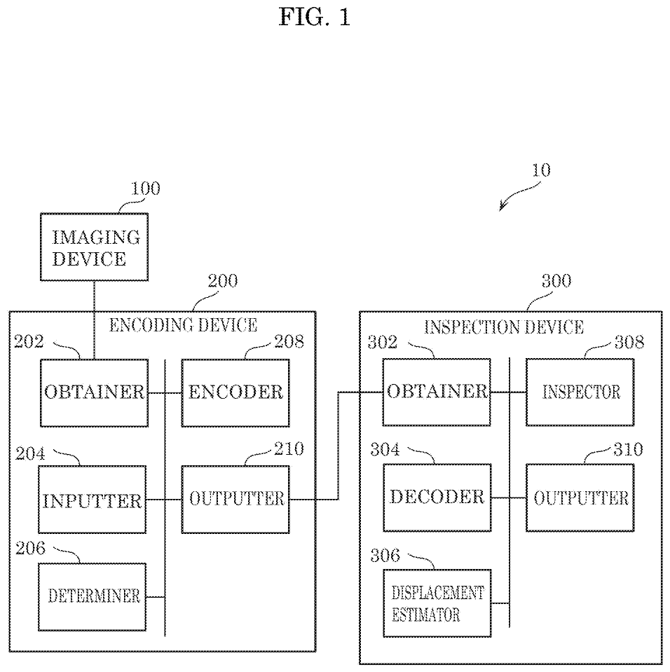

FIG. 1 is a block diagram of inspection system 10 according to the embodiment. Inspection system 10 calculates local displacement of a structure from images of the structure and inspects safety of the structure based on the calculated local displacement. As illustrated in FIG. 1, inspection system 10 includes imaging device 100, encoding device 200, and inspection device 300. The following describes the devices included in inspection system 10 one by one.

### [Configuration of Imaging Device 100]

First, a configuration of imaging device 100 will be described. Imaging device 100 is, for example, a digital video camera or a digital still camera that includes an image sensor. Imaging device 100 captures and outputs images of a structure over time.

More specifically, imaging device 100 captures images of a structure while the structure is subjected to varying loads. For example, when the structure is a railroad bridge, imaging device 100 captures images of the railroad bridge while a train is traveling on the railroad bridge.

Here, the term structure refers to a structure that is to be subjected to a load that varies by, for example, passing of a mobile body. The structure is, for example, a road, a bridge, or a tunnel.

The images are images of the same subject (i.e., structure) that are captured at different times. The images may be frames or pictures that constitute a video.

### [Configuration of Encoding Device 200]

Next, a configuration of encoding device 200 will be described. Encoding device 200 encodes images and outputs a bitstream. As illustrated in FIG. 1, encoding device 200 compression-encodes an image or a video from imaging device 100. Encoding device 200 includes obtainer 202, inputter 204, determiner 206, encoder 208, and outputter 210.

Obtainer 202 obtains the images captured by imaging device 100 via an internal or external bus, for example. For example, obtainer 202 obtains the images captured by imaging device 100 via a communication network or a recording medium.

Inputter 204 is, for example, a touch panel, a mouse, or a keyboard, and receives input from a user. For example, inputter 204 receives input from a user for specifying a region in an image or a video obtained by obtainer 202.

Determiner 206 determines a region in the images to be used for measuring local displacement of a structure as a low compression region. Moreover, determiner 206 determines that a region in the images other than the low compression region is a high compression region. The low compression region and the high compression region are examples of a first region and a second region, respectively.

Encoder 208 encodes the low compression region using a first parameter and encodes the high compression region using a second parameter. More specifically, encoder 208 encodes the images on a block-by-block basis. Furthermore, encoder 208 writes the first parameter and the second parameter in a header in the bitstream.

A block is a small region having a quadrilateral shape in an image. A block corresponds to a macroblock or a coding tree unit (CTU), for example.

The header in which the first parameter and the second parameter are written is not particularly limited. The header is, for example, a header of a macroblock, a coding unit (CU), or a transform unit (TU).

The first parameter is a coding parameter yielding less loss (i.e., encoding distortion) of the image information due to lossy compression than the second parameter. In other words, a reconstructed image of a region that is encoded using the first parameter is closer to the original image than a reconstructed image of a region that is compression-encoded using the second parameter.

For example, a quantization parameter that defines a quantization step (quantization step size) may be used as each of the first parameter and the second parameter. In this case, the quantization step defined by the first parameter is smaller than the quantization step defined by the second parameter. As a result, it is possible to reduce a quantization error and the loss of the image information due to the lossy compression in the low compression region compared with the high compression region.

For example, a quantization parameter that defines a smallest quantization step that is possible to set may be used as the first parameter. In this case, the quantization error is at a minimum in the low compression region. Therefore, the loss of the image information due to the quantization error is reduced to a minimum. Note that the standard referred to as H. 264/MPEG-4 Advanced Video Coding (AVC) and the standard referred to as H. 265/HEVC (High-Efficiency Video Coding) achieve lossless compression in which the quantization error does not occur by using the smallest quantization step that is possible to set.

For example, a parameter indicating an intra PCM (IPCM) may be used as the first parameter. In this case, because the quantization is not performed in the low compression region, the low compression region is losslessly compressed and thus the loss of the image information due to the lossy compression is reduced. Note that IPCM is encoding that does not perform prediction, conversion, quantization, or entropy coding and is defined in the standard referred to as H. 264/MPEG-4 Advanced Video Coding (AVC).

For example, a parameter indicating a skip mode may also be used as the second parameter. In this case, the skip mode is used as a fixed or preferential mode in the high compression region. Note that in the skip mode, no motion vector or transform coefficients are encoded. The skip mode is defined in the standard referred to as H. 265/HEVC (High-Efficiency Video Coding).

Determiner 206 and encoder 208 are implemented as a processor (not illustrated) and memory (not illustrated), for example. For example, a processor functions as determiner 206 and encoder 208 by executing instructions or a software program stored in memory.

Moreover, each of determiner 206 and encoder 208 may be implemented by an electronic circuit. These electronic circuits may be implemented as a single integrated electronic circuit or individual electronic circuits.

Outputter 210 outputs a bitstream including the encoded images. The bitstream may include the first parameter and the second parameter.

### [Configuration of Inspection Device 300]

Next, inspection device 300 will be described. Inspection device 300 decodes the images encoded by encoding device 200 and calculates local displacement of the structure from the decoded images. Inspection device 300 further inspects safety of the structure based on the calculated local displacement.

As illustrated in FIG. 1, inspection device 300 includes obtainer 302, decoder 304, displacement estimator 306, inspector 308, and outputter 310.

Obtainer 302 obtains the bitstream including the images encoded by encoding device 200 via an internal or external bus, for example. For example, obtainer 302 obtains the bitstream from encoding device 200 via a communication network or a recording medium.

Decoder 304 decodes the encoded images. For example, decoder 304 parses the first parameter and the second parameter from the bitstream, and decodes the encoded images using the first parameter and the second parameter.

Displacement estimator 306 estimates local displacement of the structure from the decoded images. More specifically, displacement estimator 306 estimates local displacement by performing motion estimation on each block between two images. As the motion estimation, block matching is used, for example.

Inspector 308 inspects safety of the structure based on the local displacement of the structure estimated by displacement estimator 306. For example, inspector 308 evaluates a crack on the surface of the structure and determines safety or risk of the structure. Specific examples of the determination of safety or risk include: determining necessity of a detailed check around the crack; reconsidering the time period and the interval of monitoring in the future; and determining necessity of repair.

Decoder 304, displacement estimator 306, and inspector 308 are implemented as a processor (not illustrated) and memory (not illustrated), for example. For example, a processor functions as decoder 304, displacement estimator 308, displacement estimator 306, and inspector 308 by executing instructions or a software program stored in memory.

Moreover, each of decoder 304, displacement estimator 306, and inspector 308 may be implemented as an electronic circuit. These electronic circuits may be implemented as a single integrated electronic circuit or individual electronic circuits.

Outputter 310 outputs the result of inspection performed by inspector 308. For example, outputter 310 displays one or more letters and/or an image indicating the result on a display (not illustrated).

### [Configuration of Encoding Device 200]

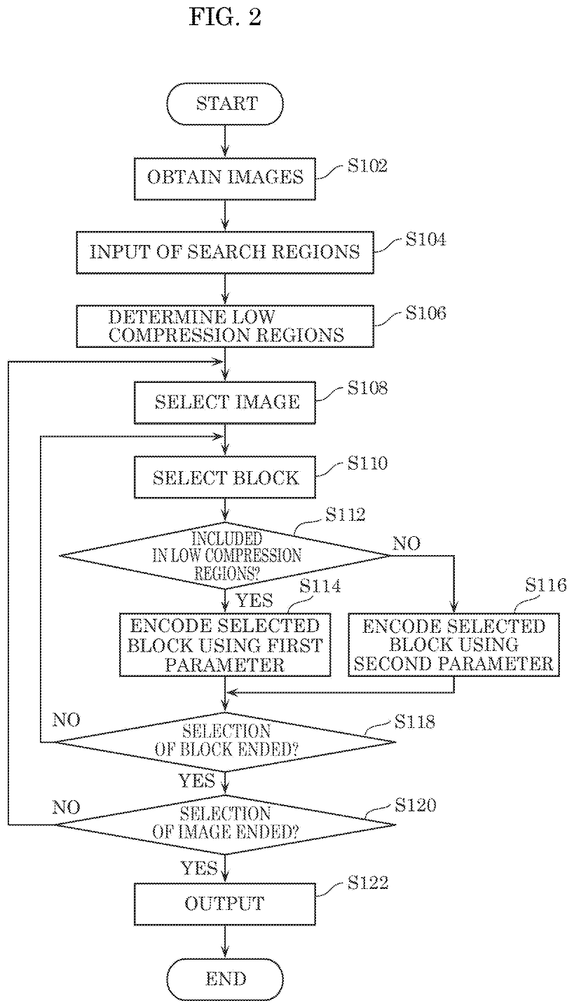

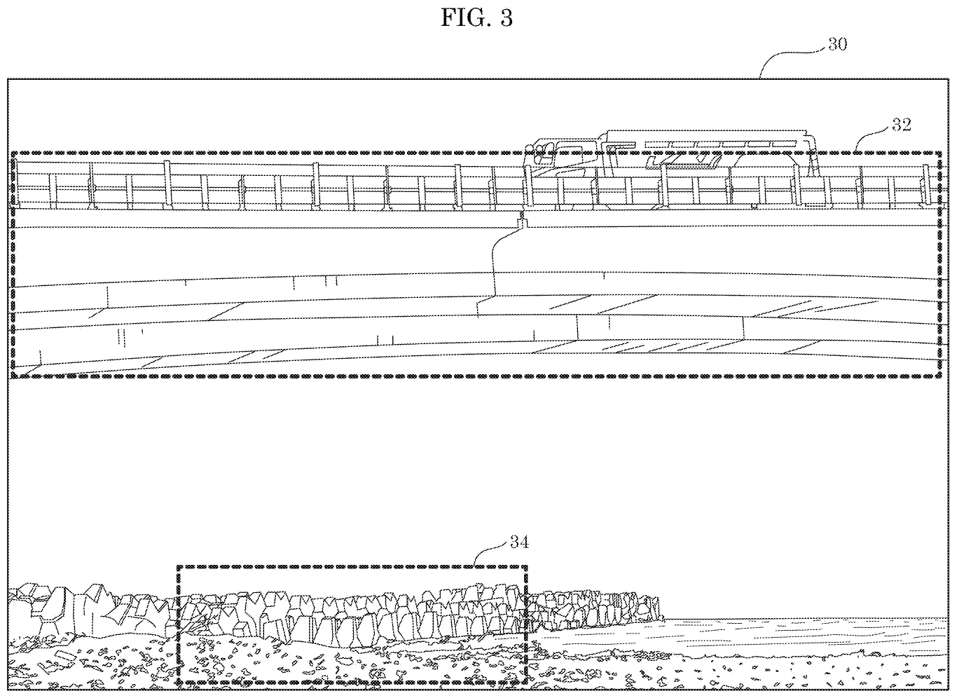

The following specifically describes a process of encoding device 200 with reference to FIG. 2 to FIG. 5. FIG. 2 is a flowchart of a process of encoding device 200 according to the embodiment. Each of FIG. 3 to FIG. 5 is a diagram of an exemplary image according to the embodiment.

As in FIG. 2, obtainer 202 obtains images captured by imaging device 100 (S102). For example, obtainer 202 obtains the images from imaging device 100 via wireless or wired communication.

Inputter 204 receives input of search regions in the images from a user (S104). Each of the search regions is an example of a third region. For example, as illustrated in FIG. 3, inputter 204 receives input specifying two search regions 32 and 34 in image 30. Here, a region including a structure (bridge), and a region not including the structure are respectively specified as search region 32 and search region 34.

Determiner 206 determines low compression regions in the search regions (S106). In other words, regions other than the search regions are not determined as the low compression regions. That is, the low compression regions are determined only within the search regions. A specific example of a method of determining the low compression regions will be described below.

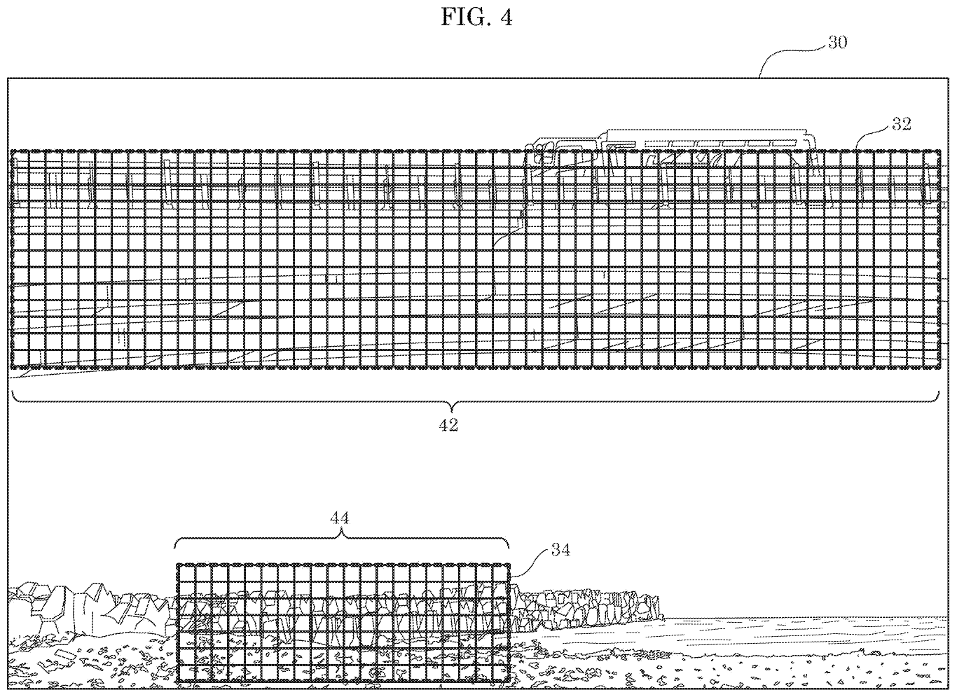

First, determiner 206 divides search regions 32 and 34 into blocks 42 and blocks 44 (see FIG. 4). Determiner 206 then performs motion estimation (block matching, for instance) on each of blocks 42 and each of blocks 44 between image 30 and another image.

As a result, a degree of reliability of the motion estimation is derived for each of blocks 42 and each of blocks 44. The degree of reliability is a value based on a sum of squared differences (SSD) in block matching, for example. In this case, the degree of reliability decreases as SSD increases. Note that a sum of absolute differences (SAD) or other measures may be used instead of SSD.

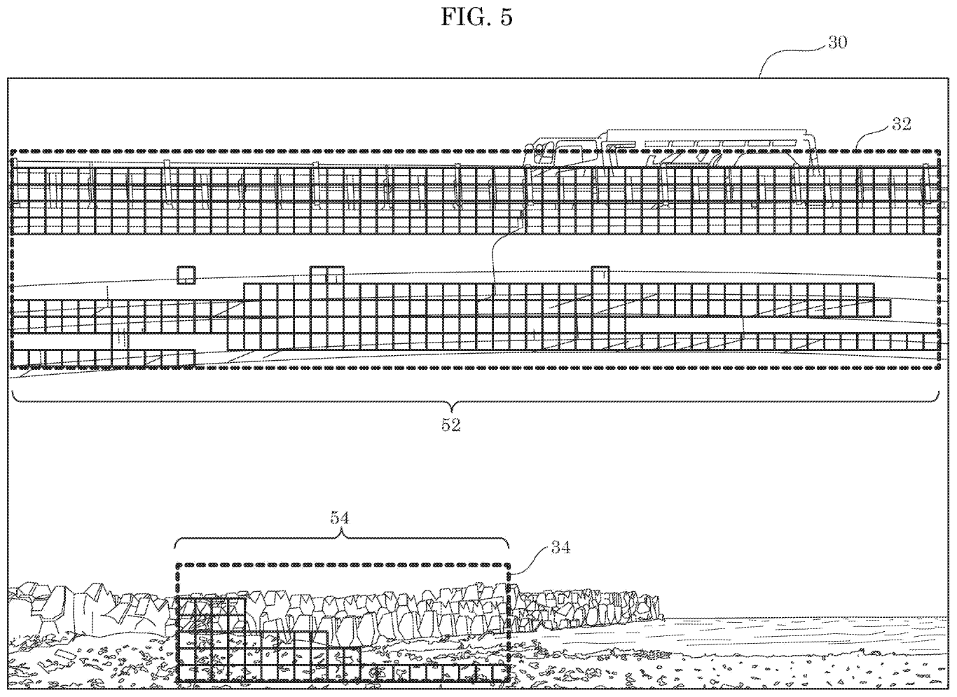

Subsequently, determiner 206 determines a block having a degree of reliability higher than a threshold degree of reliability as a low compression region from among blocks 42 and 44. In FIG. 5, blocks 52 and blocks 54 that have a high degree of reliability are determined as the low compression regions. Note that the threshold degree of reliability may be determined in advance empirically or experimentally.

With reference to FIG. 2 again, the flowchart is further described. Encoder 208 selects one image from among the images (S108). Encoder 208 then divides the selected image into blocks and selects one block from among the blocks (S110).

Encoder 208 determines whether the selected block is included in the low compression regions (S112). For example, encoder 208 determines whether the selected block is included in blocks 52 or blocks 54 in FIG. 5.

Here, when the selected block is included in the low compression regions (Yes in S112), encoder 208 encodes the selected block using the first parameter (S114). In other words, encoder 208 determines that the first parameter is to be used to encode the selected block when the selected block is included in the low compression regions. On the other hand, when the selected block is not included in the low compression regions, i.e., is in a high compression region (No in S112), encoder 208 encodes the selected block using the second parameter (S116). In other words, encoder 208 determines that the second parameter is to be used to encode the selected block when the selected block is not included in the low compression regions.

Here, when the selection of a block is ended (Yes in S118) and the selection of an image is ended (Yes in S120), outputter 210 outputs an encoded image (S122). On the other hand, when the selection of a block is not ended (No in S118), the operation returns to step S110. When the selection of an image is not ended (No in S120), the operation returns to step S108.

### [Configuration of Inspection Device 300]

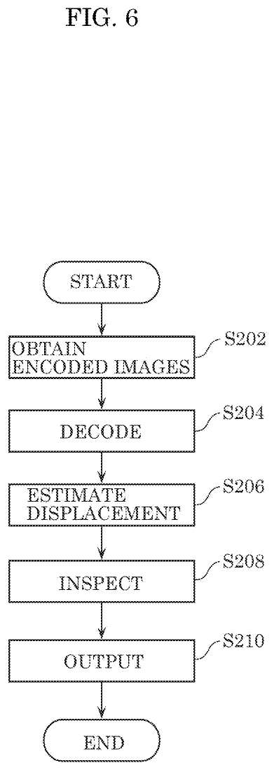

The following specifically describes a process of inspection device 300 with reference to FIG. 6. FIG. 6 is a flowchart of a process of inspection device 300 according to the embodiment.

First, obtainer 302 obtains images encoded by encoding device 200 (S202). For example, obtainer 302 obtains a bitstream including the encoded images and the first parameter and the second parameter.

Decoder 304 decodes the obtained encoded images (S204). In other words, decoder 304 decodes the encoded blocks included in the low compression regions using the first parameter and decodes the encoded blocks that are not included in the low compression regions using the second parameter.

Displacement estimator 306 estimates local displacement of the structure from the decoded images (S206). For example, displacement estimator 306 locates a matching block in a second image for each block included in the low compression regions in a first image using a block-matching algorithm to estimate displacement in each block. The first image and the second image are temporally consecutive images. Here, displacement estimator 306 estimates, in image 30 in FIG. 5, local displacement of the structure by correcting the displacement in blocks 52 included in the structure with the displacement of blocks 54 that are not included in the structure.

Inspector 308 inspects safety of the structure based on the estimated local displacement on the structure (S208). Here, the method of inspecting a structure using local displacement of the structure is not particularly limited.

Outputter 310 outputs the inspection result (S208). For example, outputter 310 outputs an image of the structure showing a position at a high risk on the structure on a display (not illustrated).

### [Working Effects, Etc.]

As described above, with encoding device 200 according to the present embodiment, the first region to be used to measure local displacement of a structure can be encoded using the first parameter yielding less loss of the image information due to the lossy compression. Therefore, a loss of the information on the first region can be reduced in the decoded image, and minute displacement of a structure can be detected highly accurately.

Moreover, with encoding device 200 according to the present embodiment, a region having a degree of reliability higher than the threshold degree of reliability of the motion estimation can be determined as the first region (i.e., low compression region). Therefore, a region suitable for the estimation of displacement can be determined as a low compression region, and minute displacement of the structure can be detected highly accurately.

Moreover, with encoding device 200 according to the present embodiment, a low compression region can be determined within the search region received from a user. Therefore, the processing load and/or processing time for determining a low compression region can be reduced compared with when the compression region is determined using all of the regions in the image.

### OTHER EMBODIMENTS

The inspection system according to one or more aspects of the present disclosure has been described above on the basis of the embodiment, but the present disclosure is not limited to the embodiment. One or more aspects of the present disclosure may include, without departing from the essence of the present disclosure, one or more variations achieved by making various modifications to the present disclosure that can be conceived by those skilled in the art.

For example, although encoding device 200 in the above embodiment is a separate device from imaging device 100, encoding device 200 may be included in imaging device 100. In this case, imaging device 100 outputs an encoded image.

Note that, although determiner 206 in encoding device 200 determines at least one low compression region based on a degree of reliability of the motion estimation in the above embodiment, but the present disclosure is not limited to such a configuration. For example, determiner 206 may determine a region having a large image feature amount as a low compression region. More specifically, determiner 206 extracts an image feature amount from at least one of the images, and determines, as a low compression region, a region whose extracted image feature amount is greater than a threshold feature amount. Note that the threshold feature amount may be determined in advance empirically or experimentally.

With this, a region having an image feature amount greater than the threshold feature amount can be determined as a low compression region. In a region having a large image feature amount, erroneous estimation of displacement can be reduced. Therefore, a region suitable for the estimation of displacement can be determined as a low compression region, and minute displacement of the structure can be detected highly accurately.

As the image feature amount, a feature amount representing unevenness of an image may be used. More specifically, as the image feature amount, an edge amount and/or a high frequency component amount may be used. For example, when the edge amount is used as the image feature amount, determiner 206 performs edge detection on at least one of the images, and determines, as a low compression region, a region having an edge amount greater than a threshold amount.

For example, when the high frequency component amount is used as the image feature amount, determiner 206 divides at least one image of the images into blocks, performs frequency conversion on each block, and determines, as a low compression region, a block having the sum of coefficients of one or more predetermined high frequency components is larger than a threshold.

Note that in the above embodiment, the first parameter used to encode the low compression region does not necessarily need to be the same value set for all of the blocks in the low compression region. Moreover, the second parameter used to encode the high compression region does not necessarily need to be the same value set for all of the blocks in the high compression region. For example, a minimum value may be uniformly set as the quantization step size for each block in the low compression region. The quantization step size for each block in the high compression region may be selectable from values greater than or equal to a predetermined threshold, and may be set appropriately according to a pattern in the image and variation in the amount of data transmission between encoding device 200 and inspection device 300.

Note that in the embodiment, the first parameter and the second parameter used to encode the low compression region and the high compression region are included in the bitstream, but the present disclosure is not limited to this configuration. For example, information for specifying the low compression region or the high compression region may be included in the bitstream instead of the first parameter and the second parameter.

Note that in the embodiment, all of the regions other than the low compression region are the high compression regions, but the present disclosure is not limited to this. For example, regions other than the low compression region may be divided into a middle compression region for which a third parameter is used and a high compression region for which the second parameter is used.

Note that in the embodiment, input of at least one search region is received from a user, but the input of the search region is not necessary. In such a case, encoding device 200 does not need to include inputter 204. Moreover, determiner 206 may determine a low compression region from all of the regions in the image.

Note that in the embodiment, the prediction of the low compression region is not particularly limited, but the prediction of the low compression region may be limited to the intra prediction. In other words, the inter prediction may be prohibited in the low compression region. In this case, inspection device 300 does not need an image different from the image to be decoded to decode the low compression region in the image to be decoded. Therefore, random accessibility for the low compression region can be improved.

Note that the low compression region is a region to be used to measure local displacement of a structure, and has a degree of reliability of motion estimation higher than the threshold degree of reliability in the embodiment. However, the low compression region may be a region including a region having a degree of reliability of motion estimation higher than the threshold degree of reliability and its surrounding region.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The present disclosure is applicable to an encoding device and an encoding method that compression-encode a plurality of images for measuring local displacement of a structure.

What is claimed is:

1. An encoding device that compression-encodes a plurality of images of a structure including a first image and a second image and being captured at mutually different times to measure local displacement of the structure, the encoding device comprising:
an inputter that receives input of a third region in the first image from a user;
a determiner that performs motion estimation, between the first image and the second image, on each of regions obtained by dividing the third region in the first image, and determines, as a first region to be used to measure local displacement of the structure, a region including a region having a degree of reliability of the motion estimation higher than a threshold degree of reliability from among the regions; and
an encoder that encodes the first region using a first parameter and encodes a second region different from the first region using a second parameter, wherein
the first parameter is a coding parameter yielding less loss of image information due to lossy compression than the second parameter.

2. The encoding device according to claim 1, wherein
the degree of reliability of the motion estimation is a value based on a sum of squared differences (SSD) in block matching between the first image and the second image.

3. The encoding device according to claim 1, wherein
the determiner:
extracts an image feature amount from at least one of the plurality of images; and
determines a region having an image feature amount greater than a threshold feature amount as the first region.

4. The encoding device according to claim 3, wherein
the image feature amount is a high frequency component amount.

5. The encoding device according to claim 3, wherein
the image feature amount is an edge amount.

6. An inspection device that decodes a plurality of images of a structure including a first image and a second image and being captured at mutually different times, and calculates local displacement of the structure from the plurality of images decoded, the inspection device comprising:
a decoder that decodes a plurality of images encoded using a first parameter and a second parameter; and
a displacement estimator that locates a matching region in the second image for each region in the first image using a block-matching algorithm to estimate local displacement of the structure, the each region in the first image being decoded using the first parameter, wherein
the first parameter is a coding parameter yielding less loss of image information due to lossy compression than the second parameter.

7. An inspection system, comprising:
the encoding device according to claim 1; and
the inspection device according to claim 6 that obtains a bitstream including the plurality of images encoded by the encoding device, the first parameter, and the second parameter.

8. An encoding method of compression-encoding a plurality of images of a structure including a first image and a second image and being captured at mutual different times to measure local displacement of the structure, the encoding method comprising:
receiving input of a third region in the first image from a user;
performing motion estimation between the first image and the second image on each of regions obtained by dividing the third region in the first image, and determining, as a first region to be used to measure local displacement of the structure, a region including a region having a degree of reliability of the motion estimation higher than a threshold degree of reliability from among the regions; and
encoding the first region using a first parameter and encoding a second region using a second parameter, the second region being different from the first region, wherein
the first parameter is a coding parameter yielding less loss of image information due to lossy compression than the second parameter.

9. An inspection method, comprising:
obtaining a bitstream including the plurality of images encoded by the encoding method according to claim 8, the first parameter, and the second parameter;
decoding the plurality of images encoded using the first parameter and the second parameter; and
locating a matching region in the second image for each region in the first image using a block-matching algorithm to estimate local displacement of the structure, the each region in the first image being decoded using the first parameter.
